(19) United States
(12) Patent Application Publication
(10) Pub. No.: US 2020/0394696 A1
(43) Pub. Date: Dec. 17, 2020

(54) ENABLING AUGMENTED REALITY TRANSACTIONS

(71) Applicant: International Business Machines Corporation, Armonk, NY (US)

(72) Inventors: RODOLFO LOPEZ, AUSTIN, TX (US); JUAN G. RIVERA, AUSTIN, TX (US); LOUIE A. DICKENS, TUCSON, AZ (US); PEDRO V. TORRES, PFLUGERVILLE, TX (US)

(21) Appl. No.: 16/438,621

(22) Filed: Jun. 12, 2019

(51) Int. Cl. G06Q 30/06; G06T 19/00; G06Q 20/32; H04W 4/021

(52) U.S. Cl. CPC G06Q 30/0623; G06T 19/006; G06Q 20/3224; H04W 4/021; G06Q 30/0635; G06Q 30/0643; G06Q 30/0609

(57) ABSTRACT

Enabling augmented reality transactions may include: sending, to a seller device, a buyer identifier associated with a buyer device; receiving, from the seller device, product metadata associated with the seller device and determined by a server based on preferences associated with the buyer identifier; and rendering, as an augmented reality (AR) overlay, the product metadata relative to the seller device.

### BACKGROUND

### Field of the Invention

The field of the invention is data processing, or, more specifically, methods, apparatus, and products for enabling augmented reality transactions.

### Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

### SUMMARY

Enabling augmented reality transactions may include: sending, to a seller device, a buyer identifier associated with a buyer device; receiving, from the seller device, product metadata associated with the seller device and determined by a server based on preferences associated with the buyer identifier; and rendering, as an augmented reality (AR) overlay, the product metadata relative to the seller device.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram of an example system for enabling augmented reality transactions according to embodiments of the present disclosure.

FIG. 2 is a block diagram of an example computing device for enabling augmented reality transactions according to embodiments of the present disclosure.

FIG. 3 is an example user interface for enabling augmented reality transactions according to embodiments of the present disclosure.

FIG. 4 is a flowchart of an example method for enabling augmented reality transactions according to embodiments of the present disclosure.

FIG. 5 is a flowchart of an example method for enabling augmented reality transactions according to embodiments of the present disclosure.

FIG. 6 is a flowchart of an example method for enabling augmented reality transactions according to embodiments of the present disclosure.

FIG. 7 is a flowchart of an example method for enabling augmented reality transactions according to embodiments of the present disclosure.

FIG. 8 is a flowchart of an example method for enabling augmented reality transactions according to embodiments of the present disclosure.

### DETAILED DESCRIPTION

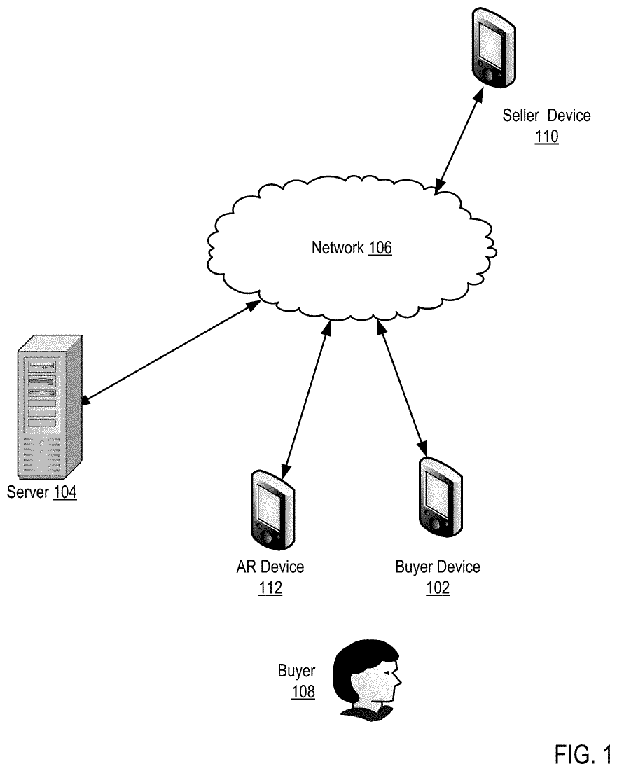

Exemplary methods, apparatus, and products for enabling augmented reality transactions in accordance with the present invention are described with reference to the accompanying drawings, beginning with FIG. 1. FIG. 1 sets forth a network diagram of a system configured for enabling augmented reality transactions according to embodiments of the present invention. The system of FIG. 1 includes a buyer device 102 connected to a server 104 via a network 106. The buyer device 102 may comprise a mobile device, a wearable device (e.g., smart watch, fitness tracker, smart glasses, etc.), or other computing device as can be appreciated. A user of the buyer device 102, hereinafter referred to as a buyer 108, may send preferences to the server 104. The preferences comprise indications of topics or products of interest to facilitate later identification of relevant products for purchase. For example, the preferences may indicate individual products that the buyer 108 is interested in purchasing. As another example, the preferences may indicate topics or categories of interest that may be related to multiple products (e.g., brands, item categories, manufacturers, color schemes or patterns, etc.). The buyer device 102 may send the preferences to the server 104 using a web interface, an application interface, or another interface as can be appreciated.

The server 104 may then generate, for the buyer device 102, a buyer identifier. The buyer identifier may comprise a unique identifier for the buyer device 102. Accordingly, the buyer identifier may comprise a unique randomly generated identifier, a unique sequentially generated identifier, a hardware identifier (e.g., serial number of Media Access Controller (MAC) address) of the buyer device 102, or generated derivatives thereof. The server 104 may then store the preferences (e.g., in a database or data store) associated with the buyer identifier. For example, the buyer identifier may serve as a key to the corresponding value of the preferences.

The buyer device 102 may execute a buyer application configured to determine when the buyer device 102 is proximate to a seller device 110. A seller device 110 is a device associated with a seller or marketer of one or more products. The seller device 110 may comprise a mobile device, wearable device, or other portable computing device. The seller device 110 may also comprise a dedicated microprocessor device housed in a casing or housing that can be clipped or otherwise attached to a garment or person. Accordingly, the seller device 110 may be worn by a seller or other user. The seller device 110 may also comprise a stationary computing device at a fixed location. The seller device 110 may execute a seller application configured to facilitate enabling augmented reality transactions as will be described below. The seller device 110 may be associated with a seller identifier (e.g., a unique identifier associated with the seller device 110).

Determining, by the buyer device 102, that the buyer device 102 is proximate to the seller device 110 may comprise detecting a beacon or signal generated by the seller device 110. For example, the seller application may be configured to broadcast the seller identifier as a beacon or signal that may be received by the buyer device 102. The seller application may be configured to broadcast a pairing request that may be detected by the buyer device 102. For example, the pairing request may comprise a request to establish a personal area network (e.g., Bluetooth) connection or other wireless connection with a buyer device 102. Determining that the buyer device 102 is proximate to the seller device 110 may comprise receiving a Near Field Communication (NFC) signal from the seller device 110.

Determining, by the buyer device 102, that the buyer device 102 is proximate to the seller device 110 may be based on a geofence. The geofence may comprise a fixed geofence encompassing a predefined geographic area. The geofence may also comprise a geofence relative to the buyer device 102 or seller device 110 (e.g., a diameter or distance relative to the buyer device 102 or seller device 110). Accordingly, determining, by the buyer device 102, that the buyer device 102 is proximate to the seller device 110 may comprise determining that the buyer device 102 and the seller device 110 are within the same geofence. For example, the buyer device 102 and/or the seller device 110 may send, to the server 104, location data indicating the current location of the device 102 and/or the seller device 110. The server 104 may then determine, based on the location data, that the buyer device 102 and the seller device 110 are within the geofence.

The server 104 may then send an indication, to the buyer device 102 and seller device 110, that the buyer device 102 and the seller device 110 are in the same geofence. The indication may then cause the seller device 110 to send beacons, signals, or requests to facilitate establishing a session between the buyer device 102 and the seller device 110.

In response to determining that the buyer device 102 is proximate to the seller device 110, the buyer device 102 may establish a session with the seller device 110. Establishing the session may comprise establishing a wireless network connection between the buyer device 102 and the seller device 110. Establishing the session may also include sending, by the buyer device 102, the buyer identifier to the seller device 110.

Sending, by the buyer device 102, the buyer identifier to the seller device 110 may cause the seller device 110 to send the buyer identifier and the seller identifier to the server 104. The server 104 may identify, based on the buyer identifier, the preferences associated with the buyer device 102. The server 104 may then identify, based on the preferences, one or more products associated with the seller device 110. For example, assume that the server 104 maintains an inventory or listing of purchasable products associated with the seller device 110 (e.g., associated with the seller identifier). The server 104 may identify, from the inventory, one or more relevant products based on the preferences. For example, the server 104 may identify products in the inventory that are listed in the preferences. The server 104 may also identify products in the inventory that are similar to products listed in the preferences. The server 104 may also identify products in the inventory that are classified into categories, topics, or other groupings indicated in the preferences.

The server 104 may then send product metadata of the relevant products to the seller device 110. The product metadata may include a product description, a product image, a price, a number of products available for purchase, or other metadata as can be appreciated. The product metadata may also include metadata associated with the session between the buyer device 102 and the seller device 110, including time stamps, geolocation data, or other data. The seller device 110 may then send the product metadata to the buyer device 102.

The product metadata may then be rendered, by an augmented reality (AR) device 112, as an AR overlay relative to the seller device 110. The AR device 112 is a computing device capable of rendering images, videos, objects, or other data as an overlay on a view of a physical space. The AR device 112 may comprise a computing device (e.g., a wearable device such as smart glasses or another device) in communication with the buyer device 102 (e.g., paired using Bluetooth or another short range wireless network). For example, rendering the product metadata may comprise sending, by the buyer device 102, to the AR device 112, a notification that product metadata has been received. The AR device 112 may then render the product metadata in response to an acknowledgement of the notification. The buyer device 102 may also be configured to automatically send the product metadata to the AR device 112, and the AR device 112 may be configured to automatically render the received product metadata.

The buyer device 102 and the AR device 112 may also comprise the same device. For example, the buyer device 102 may comprise a smart phone with a camera and other hardware (e.g., gyroscopes, location sensors, etc.) that allow the smart phone to perform AR functionality. Accordingly, the buyer device 102 may be configured to render the overlay on a video image captured by a camera of the buyer device 102.

The overlay is rendered relative to the seller device 110 in that the overlay appears in a field of view of the AR device 112 at a position relative to the seller device 110. Thus, as a position of the seller device 110 changes in the field of view of the AR device 112 (e.g., due to movement of the seller device 110 and/or movement of the AR device 112), the rendered position of the overlay with change accordingly. The product metadata may be rendered as a header, popup window, or other overlay. The product metadata may be processed for rendering as an AR overlay using an AR framework such as ARKit or ARCode. The product metadata may be processed using the AR framework by the server 104, the seller device 110, the buyer device 102, and/or the AR device 112.

The AR device 112 may receive an indication of disinterest for the rendered product metadata. The indication of disinterest comprises an indication that the buyer 108 has no intention to purchase a product associated with the rendered product metadata at that time. Indications of disinterest may comprise looking away or otherwise removing the overlay from the field of view of the AR device 112. Indications of disinterest may comprise a voice command. Indications of disinterest may also comprise an input to the overlay (e.g., a touch gesture, selecting a “close” or “next” button). For example, where the overlay is rendered on a video displayed on a mobile device, the indication of disinterest may comprise swiping the overlay, swiping the overlay in a predefined direction (e.g., swiping left for disinterest), tapping a rendered button or other user interface element, or another action. Indications of disinterest may also comprise detectable physical gestures made in freespace within a field of view of the AR device 112. For example, a buyer 108 may make a gesture (e.g., swiping, waving, etc.) in free space. The gesture may then be detected by the AR device 112.

In response to receiving the indication of disinterest, the AR device 112 may render other product metadata as another AR overlay relative to the seller device 110. Where product metadata for multiple products was received from the seller device 110, product metadata for a second product may be rendered in response to receiving an indication of disinterest for a first product. For example, the seller device 110 may receive paginated product metadata from the server 104 and send all or a portion of the paginated product metadata to the buyer device 102 and/or AR device 112. A request may also be sent to the seller device 110 (e.g., via the buyer device 102) for additional product metadata in response to receiving the indication of disinterest. Where no additional product metadata is available, the AR device 112 may cease rendering an overlay associated with the seller device 110.

The indication of disinterest may be sent to the server 104 (e.g., directly by the AR device 112 or the buyer device 102, or via the seller device 110). The server 104 may update the preferences based on the indication of disinterest. For example, where the indication of disinterest was made for a product indicated in the preferences, the product may be removed from the preferences as the buyer 108 may no longer be interested in purchasing it. As another example, a disinterest count associated with the product may be updated. The disinterest count may indicate a number of times an indication of disinterest has been received for that product. The product may be removed from the preferences, or excluded from future product metadata, in response to the disinterest count meeting the threshold. As a further example, categories or topics associated with a product for which an indication of disinterest was received may be weighted or scored differently to reflect a lesser degree of interest in the category or topic.

The AR device 112 may receive an indication to purchase a product associated with the rendered product metadata. Indications to purchase a product may comprise a predefined voice command (e.g., “Buy”). Indications of interest may also comprise an input to the overlay (e.g., a touch gesture, selecting a “Buy” button). For example, where the overlay is rendered on a video displayed on a mobile device, the indication of interest may comprise swiping the overlay, swiping the overlay in a predefined direction (e.g., swiping right for purchase), tapping a rendered button or other user interface element, or another action. Indications to purchase may also comprise detectable physical gestures made in freespace within a field of view of the AR device 112. For example, a buyer 108 may make a gesture (e.g., swiping, waving, etc.) in free space. The gesture may then be detected by the AR device 112. In response to receiving the indication to purchase, a transaction to purchase the product associated with the rendered product metadata may be performed. For example, a command or signal may be sent to the server 104 to enter an electronic commerce workflow to purchase the product (e.g., using the buyer device 102 and/or the AR device 112).

The indication to purchase the product may be sent to the server 104 (e.g., directly by the AR device 112 or the buyer device 102, or via the seller device 110). The server 104 may update the preferences based on the indication to purchase. For example, where the indication to purchase was made for a product indicated in the preferences, the product may be removed from As a further example, categories or topics associated with a product for which an indication to purchase was received may be weighted or scored differently to reflect a greater degree of interest in the category or topic.

The arrangement of servers and other devices making up the exemplary system illustrated in FIG. 1 are for explanation, not for limitation. Data processing systems that are useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

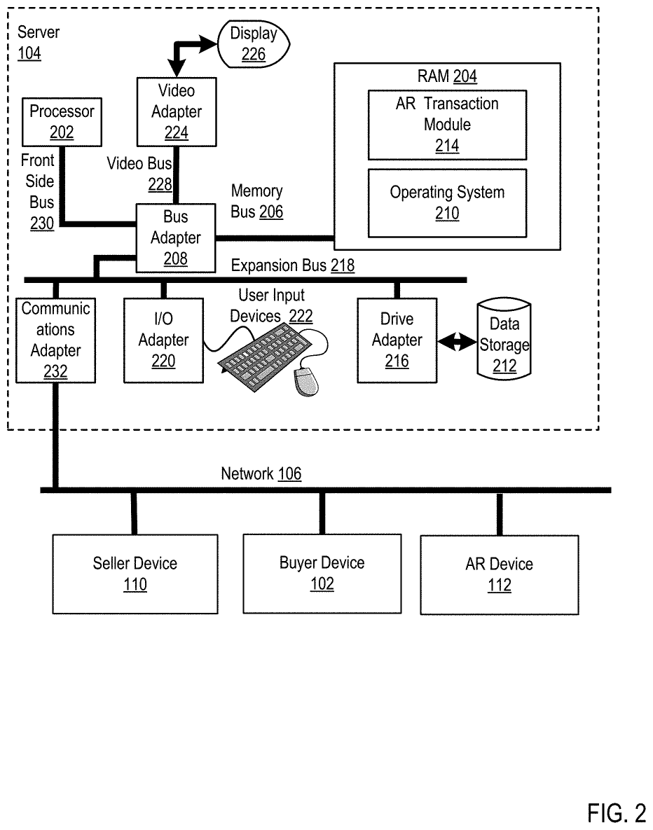

Enabling augmented reality transactions in accordance with the present invention is generally implemented with computers, that is, with automated computing machinery. For further explanation, therefore, FIG. 2 sets forth a block diagram of automated computing machinery comprising an exemplary server 104 configured for enabling augmented reality transactions according to embodiments of the present invention. The server 104 of FIG. 2 includes at least one computer processor 202 or ‘CPU’ as well as random access memory 204 (RAM') which is connected through a high speed memory bus 206 and bus adapter 208 to processor 202 and to other components of the server 104.

Stored in RAM 204 is an operating system 210. Operating systems useful in computers configured for enabling augmented reality transactions according to embodiments of the present invention include UNIX, Linux™, Microsoft Windows™, AIX™, IBM's i OS™, and others as will occur to those of skill in the art. The operating system 210 in the example of FIG. 2 is shown in RAM 204, but many components of such software typically are stored in non-volatile memory also, such as, for example, on data storage 212, such as a disk drive. Also stored in RAM is the AR transaction module 214 a module for enabling augmented reality transactions according to embodiments of the present invention.

The server 104 of FIG. 2 includes disk drive adapter 216 coupled through expansion bus 218 and bus adapter 208 to processor 202 and other components of the server 104. Disk drive adapter 216 connects non-volatile data storage to the server 104 in the form of data storage 212. Disk drive adapters useful in computers configured for enabling augmented reality transactions according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example server 104 of FIG. 2 includes one or more input/output (‘I/O’) adapters 220. I/O adapters implement user-oriented input/output through, for example, software drivers and computer hardware for controlling output to display devices such as computer display screens, as well as user input from user input devices 222 such as keyboards and mice. The example server 104 of FIG. 2 includes a video adapter 224, which is an example of an I/O adapter specially designed for graphic output to a display device 226 such as a display screen or computer monitor. Video adapter 224 is connected to processor 202 through a high speed video bus 228, bus adapter 208, and the front side bus 230, which is also a high speed bus.

The exemplary server 104 of FIG. 2 includes a communications adapter 232 for data communications with other computers and for data communications with a data communications network 106. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for enabling augmented reality transactions according to embodiments of the present invention include modems for wired dial-up communications, Ethernet (IEEE 802.3) adapters for wired data communications, and 802.11 adapters for wireless data communications.

The communications adapter 232 is communicatively coupled to a network 106 that also includes one or more seller devices 110, one or more buyer devices 102, and/or one or more AR devices 112.

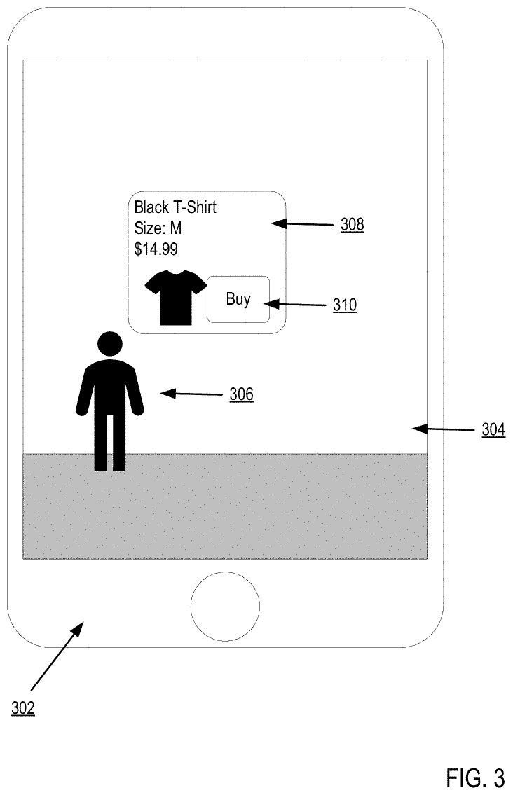

For further explanation, FIG. 3 shows an example user interface for enabling augmented reality transactions according to embodiments of the present invention. Here, the example user interface is rendered by a mobile device 302 that serves as both a buyer device 102 and an AR device 112. It is understood that similar interfaces may be rendered on AR devices 112 remote from a separate buyer device 102 (e.g., wearables or smart devices communicatively coupled to a mobile device).

The example user interface shows a field of view 304 including a seller 306 carrying a seller device 110. A session has been established between the mobile device 302 and the seller device 110 of the seller 306. Product metadata has been received for a black medium t-shirt according to seller inventory and buyer preferences. An overlay 308 comprising the product metadata is rendered above the seller 306 (e.g., relative to the seller device 110). The overlay 308 includes a “Buy” button 310 that, if selected, may initiate an electronic commerce transaction to purchase the product featured in the overlay 308.

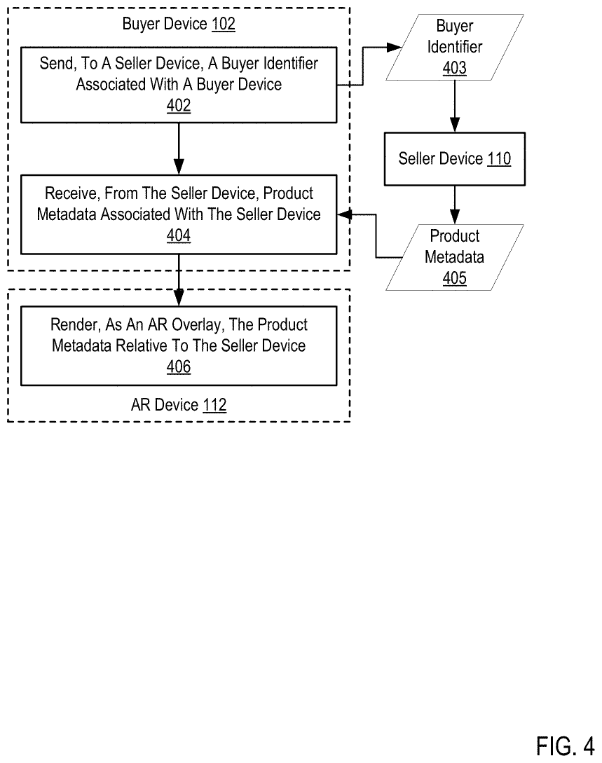

For further explanation, FIG. 4 sets forth a flow chart illustrating an exemplary method for enabling augmented reality transactions according to embodiments of the present invention that includes sending 402 (e.g., by a buyer device 102), to a seller device 110, a buyer identifier 403 associated with a buyer device 102. The buyer device 102 may send the buyer identifier 403 to the seller device 110 via a short range wireless connection, near-field communication (NFC), or via another connection. The buyer identifier 403 may comprise a unique identifier for the buyer device 102. Accordingly, the buyer identifier may comprise a unique randomly generated identifier, a unique sequentially generated identifier, a hardware identifier (e.g., serial number of Media Access Controller (MAC) address) of the buyer device 102, or generated derivatives thereof.

The method of FIG. 4 also includes receiving 404 (e.g., by the buyer device 102), from the seller device 110, product metadata 405 associated with the seller device 110. The product metadata 405 may be determined by a server 104 based on preferences associated with a buyer identifier 403. For example, sending 402, by the buyer device 102, the buyer identifier 403 to the seller device 110 may cause the seller device 110 to send the buyer identifier and a seller identifier to a server 104. The server 104 may identify, based on the buyer identifier 403, preferences associated with the buyer device 102. The server 104 may then identify, based on the preferences, one or more products associated with the seller device 110. For example, assume that the server 104 maintains an inventory or listing of purchasable products associated with the seller device 110 (e.g., associated with the seller identifier). The server 104 may identify, from the inventory, one or more relevant products based on the preferences. For example, the server 104 may identify products in the inventory that are listed in the preferences. The server 104 may also identify products in the inventory that are similar to products listed in the preferences. The server 104 may also identify products in the inventory that are classified into categories, topics, or other groupings indicated in the preferences.

The server 104 may then send product metadata of the relevant products to the seller device 110. The product metadata may include a product description, a product image, a price, a number of products available for purchase, or other metadata as can be appreciated. The product metadata may also include metadata associated with the session between the buyer device 102 and the seller device 110, including time stamps, geolocation data, or other data. The seller device 110 may then send the product metadata to the buyer device 102.

The method of FIG. 4 may also include rendering 406 (e.g., by an augmented reality (AR) device 112), as an AR overlay, the product metadata 405 relative to the seller device 110. For example, rendering the product metadata 405 may comprise sending, by the buyer device 102, to the AR device 112, a notification that product metadata 405 has been received. The AR device 112 may then render the product metadata 405 in response to an acknowledgement of the notification. The buyer device 102 may also be configured to automatically send the product metadata 405 to the AR device 112, and the AR device 112 may be configured to automatically render the received product metadata 405.

The overlay is rendered relative to the seller device 110 in that the overlay appears in a field of view of the AR device 112 at a position relative to the seller device 110. Thus, as a position of the seller device 110 changes in the field of view of the AR device 112 (e.g., due to movement of the seller device 110 and/or movement of the AR device 112), the rendered position of the overlay with change accordingly. The product metadata 405 may be rendered as a header, popup window, or other overlay. The product metadata 405 may be processed for rendering as an AR overlay using an AR framework such as ARKit or ARCode. The product metadata 405 may be processed using the AR framework by the server 104, the seller device 110, the buyer device 102, and/or the AR device 112.

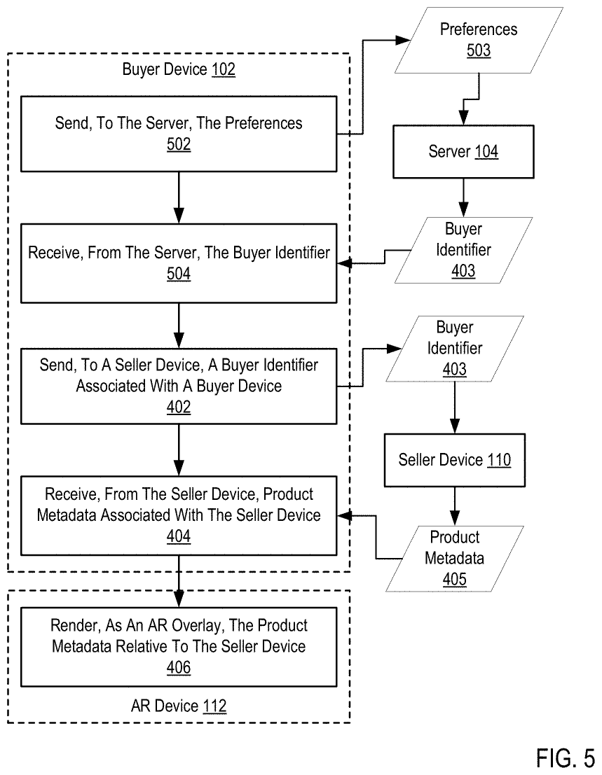

For further explanation, FIG. 5 sets forth a flow chart illustrating an exemplary method for enabling augmented reality transactions according to embodiments of the present invention that includes sending 402 (e.g., by a buyer device 102), to a seller device 110, a buyer identifier 403 associated with a buyer device 102; receiving 404, from the seller device 110, product metadata 405 associated with the seller device 110; and rendering 406 (e.g., by an AR device 112), as an AR overlay, the product metadata 405 relative to the seller device 110.

The method of FIG. 5 differs from FIG. 4 in that the method of FIG. 5 also includes sending 502, to the server 104, the preferences 503. The preferences 503 comprise indications of topics or products of interest to facilitate later identification of relevant products for purchase. For example, the preferences 503 may indicate individual products that the buyer 108 is interested in purchasing. As another example, the preferences 503 may indicate topics or categories of interest that may be related to multiple products (e.g., brands, item categories, manufacturers, color schemes or patterns, etc.). The buyer device 102 may send the preferences 503 to the server 104 using a web interface, an application interface, or another interface as can be appreciated.

The method of FIG. 5 further differs from FIG. 4 in that the method of FIG. 5 includes receiving 504, from the server 104, the buyer identifier 403. For example, the server 104 may generate the buyer identifier 403 and store the preferences (e.g., in a database or data store) associated with the buyer identifier 403. For example, the buyer identifier may serve as a key to the corresponding value of the preferences. The server 104 may then send the buyer identifier 403 to the buyer device 102. The buyer device 102 may then store the buyer identifier 403 for later use by a buyer application.

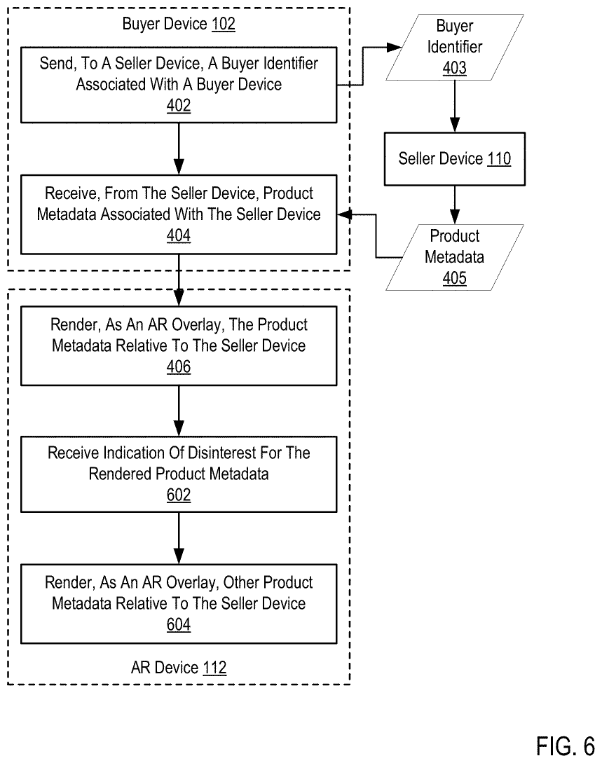

For further explanation, FIG. 6 sets forth a flow chart illustrating an exemplary method for enabling augmented reality transactions according to embodiments of the present invention that includes sending 402 (e.g., by a buyer device 102), to a seller device 110, a buyer identifier 403 associated with a buyer device 102; receiving 404, from the seller device 110, product metadata 405 associated with the seller device 110; and rendering 406 (e.g., by an AR device 112), as an AR overlay, the product metadata 405 relative to the seller device 110.

The method of FIG. 6 differs from FIG. 4 in that the method of FIG. 6 also includes receiving 602 (e.g., by the AR device 112) an indication of disinterest for the rendered product metadata 405. The indication of disinterest comprises an indication that the buyer 108 has no intention to purchase a product associated with the rendered product metadata 405 at that time. Indications of disinterest may comprise looking away or otherwise removing the overlay from the field of view of the AR device 112. Indications of disinterest may comprise a voice command. Indications of disinterest may also comprise an input to the overlay (e.g., a touch gesture, selecting a “close” or “next” button). For example, where the overlay is rendered on a video displayed on a mobile device, the indication of disinterest may comprise swiping the overlay, swiping the overlay in a predefined direction (e.g., swiping left for disinterest), tapping a rendered button or other user interface element, or another action. Indications of disinterest may also comprise detectable physical gestures made in freespace within a field of view of the AR device 112. For example, a buyer 108 may make a gesture (e.g., swiping, waving, etc.) in free space. The gesture may then be detected by the AR device 112.

The indication of disinterest may be sent to the server 104 (e.g., directly by the AR device 112 or the buyer device 102, or via the seller device 110). The server 104 may update the preferences based on the indication of disinterest. For example, where the indication of disinterest was made for a product indicated in the preferences, the product may be removed from the preferences as the buyer 108 may no longer be interested in purchasing it. As another example, a disinterest count associated with the product may be updated. The disinterest count may indicate a number of times an indication of disinterest has been received for that product. The product may be removed from the preferences, or excluded from future product metadata, in response to the disinterest count meeting the threshold. As a further example, categories or topics associated with a product for which an indication of disinterest was received may be weighted or scored differently to reflect a lesser degree of interest in the category or topic.

The method of FIG. 6 further differs from FIG. 4 in that the method of FIG. 6 also includes rendering 604 other product metadata 405 as another AR overlay relative to the seller device 110. For example, where product metadata 405 for multiple products was received from the seller device 110, product metadata 405 for a second product may be rendered in response to receiving an indication of disinterest for a first product. A request may also be sent to the seller device 110 (e.g., via the buyer device 102) for additional product metadata 405 in response to receiving the indication of disinterest. Where no additional product metadata 405 is available, the AR device 112 may cease rendering an overlay associated with the seller device 110.

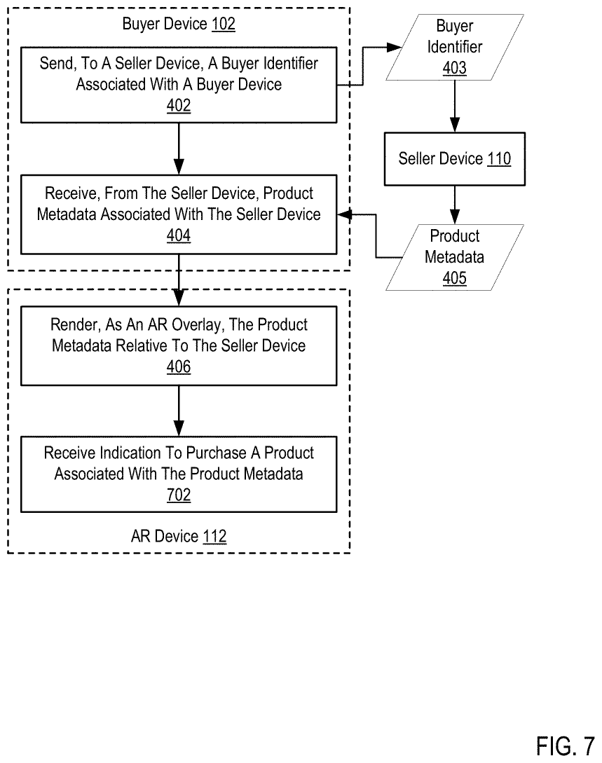

For further explanation, FIG. 7 sets forth a flow chart illustrating an exemplary method for enabling augmented reality transactions according to embodiments of the present invention that includes sending 402 (e.g., by a buyer device 102), to a seller device 110, a buyer identifier 403 associated with a buyer device 102; receiving 404, from the seller device 110, product metadata 405 associated with the seller device 110; and rendering 406 (e.g., by an AR device 112), as an AR overlay, the product metadata 405 relative to the seller device 110.

The method of FIG. 7 differs from FIG. 4 in that the method of FIG. 7 also includes receiving702 an indication to purchase a product associated with the rendered product metadata 405. Indications to purchase a product may comprise a predefined voice command (e.g., “Buy”). Indications of interest may also comprise an input to the overlay (e.g., a touch gesture, selecting a “Buy” button). For example, where the overlay is rendered on a video displayed on a mobile device, the indication of interest may comprise swiping the overlay, swiping the overlay in a predefined direction (e.g., swiping right for purchase), tapping a rendered button or other user interface element, or another action. Indications to purchase may also comprise detectable physical gestures made in freespace within a field of view of the AR device 112. For example, a buyer 108 may make a gesture (e.g., swiping, waving, etc.) in free space. The gesture may then be detected by the AR device 112. In response to receiving the indication to purchase, a transaction to purchase the product associated with the rendered product metadata 405 may be performed. For example, a command or signal may be sent to the server 104 to enter an electronic commerce workflow to purchase the product (e.g., using the buyer device 102 and/or the AR device 112).

The indication to purchase the product may be sent to the server 104 (e.g., directly by the AR device 112 or the buyer device 102, or via the seller device 110). The seller device 104 may update the preferences based on the indication to purchase. For example, where the indication to purchase was made for a product indicated in the preferences, the product may be removed from As a further example, categories or topics associated with a product for which an indication to purchase was received may be weighted or scored differently to reflect a greater degree of interest in the category or topic.

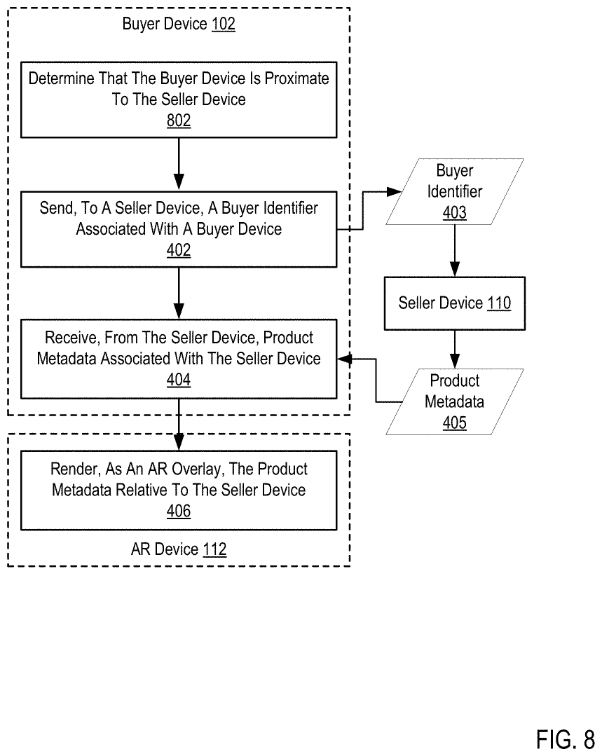

For further explanation, FIG. 8 sets forth a flow chart illustrating an exemplary method for enabling augmented reality transactions according to embodiments of the present invention that includes sending 402 (e.g., by a buyer device 102), to a seller device 110, a buyer identifier 403 associated with a buyer device 102; receiving 404, from the seller device 110, product metadata 405 associated with the seller device 110; and rendering 406 (e.g., by an AR device 112), as an AR overlay, the product metadata 405 relative to the seller device 110.

The method of FIG. 8 differs from FIG. 4 in that the method of FIG. 8 also includes determining 802 (e.g., by the buyer device 102), that the buyer device 102 is proximate to the seller device 110. Determining, by the buyer device 102, that the buyer device 102 is proximate to the seller device 110 may comprise detecting a beacon or signal generated by the seller device 110. For example, the seller application may be configured to broadcast the seller identifier as a beacon or signal that may be received by the buyer device 102. The seller application may be configured to broadcast a pairing request that may be detected by the buyer device 102. For example, the pairing request may comprise a request to establish a personal area network (e.g., Bluetooth) connection or other wireless connection with a buyer device 102. Determining that the buyer device 102 is proximate to the seller device 110 may comprise receiving a Near Field Communication (NFC) signal from the seller device 110.

Determining, by the buyer device 102, that the buyer device 102 is proximate to the seller device 110 may be based on a geofence. The geofence may comprise a fixed geofence encompassing a predefined geographic area. The geofence may also comprise a geofence relative to the buyer device 102 or seller device 110 (e.g., a diameter or distance relative to the buyer device 102 or seller device 110). Accordingly, determining, by the buyer device 102, that the buyer device 102 is proximate to the seller device 110 may comprise determining that the buyer device 102 and the seller device 110 are within the same geofence. For example, the buyer device 102 and/or the seller device 110 may send, to the server 104, location data indicating the current location of the device 102 and/or the seller device 110. The server 104 may then determine, based on the location data, that the buyer device 102 and the seller device 110 are within the geofence.

The server 104 may then send an indication, to the buyer device 102 and seller device 110, that the buyer device 102 and the seller device 110 are in the same geofence. The indication may then cause the seller device 110 to send beacons, signals, or requests to facilitate establishing a session between the buyer device 102 and the seller device 110.

In response to determining that the buyer device 102 is proximate to the seller device 110, the buyer device 102 may establish a session with the seller device 110. Establishing the session may comprise establishing a wireless network connection between the buyer device 102 and the seller device 110. Establishing the session may also include sending, by the buyer device 102, the buyer identifier to the seller device 110.

In view of the explanations set forth above, readers will recognize that the benefits of enabling augmented reality transactions according to embodiments of the present invention include:
Improving product discoverability by linking product purchases to an AR environment.
Improved user experiences in discovering interested products through an AR environment.
Extension of the AR environment and product purchasing to outdoor environments.

Exemplary embodiments of the present invention are described largely in the context of a fully functional computer system for enabling augmented reality transactions. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of enabling augmented reality transactions, the method comprising:
sending, to a seller device, a buyer identifier associated with a buyer device;
receiving, from the seller device, product metadata associated with the seller device and determined by a server based on preferences associated with the buyer identifier; and
rendering, as an augmented reality (AR) overlay, the product metadata relative to the seller device.

2. The method of claim 1, wherein sending, to the seller device, the buyer identifier causes the seller device to:
send the buyer identifier and a seller identifier to a server; and
receive, from the server, the product metadata.

3. The method of claim 1, further comprising:
sending, to the server, the preferences; and
receiving, from the server, the buyer identifier.

4. The method of claim 1, further comprising:
receive an indication of disinterest for the rendered product metadata; and
rendering other product metadata as another AR overlay relative to the seller device.

5. The method of claim 1, further comprising receiving an indication to purchase a product associated with the rendered product metadata.

6. The method of claim 1, wherein sending the buyer identifier is performed in response to determining that the buyer device is proximate to the seller device.

7. The method of claim 6, further comprising determining that the buyer device is proximate to the seller device based on one or more of: a geofence relative to the seller device or a signal received from the seller device.

8. An apparatus for enabling augmented reality transactions, the apparatus comprising a computer processor, a computer memory operatively coupled to the computer processor, the computer memory having disposed within it computer program instructions that, when executed by the computer processor, cause the apparatus to carry out the steps of:
sending, to a seller device, a buyer identifier associated with a buyer device;
receiving, from the seller device, product metadata associated with the seller device and determined by a server based on preferences associated with the buyer identifier; and
rendering, as an augmented reality (AR) overlay, the product metadata relative to the seller device.

9. The apparatus of claim 8, wherein sending, to the seller device, the buyer identifier causes the seller device to:
send the buyer identifier and a seller identifier to a server; and
receive, from the server, the product metadata.

10. The apparatus of claim 8, wherein the steps further comprise:
sending, to the server, the preferences; and
receiving, from the server, the buyer identifier.

11. The apparatus of claim 8, wherein the steps further comprise:
receive an indication of disinterest for the rendered product metadata; and
rendering other product metadata as another AR overlay relative to the seller device.

12. The apparatus of claim 8, wherein the steps further comprise receiving an indication to purchase a product associated with the rendered product metadata.

13. The apparatus of claim 8, wherein sending the buyer identifier is performed in response to determining that the buyer device is proximate to the seller device.

14. The apparatus of claim 13, wherein the steps further comprise determining that the buyer device is proximate to the seller device based on one or more of: a geofence relative to the seller device or a signal received from the seller device.

15. A computer program product for enabling augmented reality transactions, the computer program product disposed upon a computer readable medium, the computer program product comprising computer program instructions that, when executed, cause a computer to carry out the steps of:
sending, to a seller device, a buyer identifier associated with a buyer device;
receiving, from the seller device, product metadata associated with the seller device and determined by a server based on preferences associated with the buyer identifier; and
rendering, as an augmented reality (AR) overlay, the product metadata relative to the seller device.

16. The computer program product of claim 15, wherein sending, to the seller device, the buyer identifier causes the seller device to:
send the buyer identifier and a seller identifier to a server; and
receive, from the server, the product metadata.

17. The computer program product of claim 15, wherein the steps further comprise:
sending, to the server, the preferences; and
receiving, from the server, the buyer identifier.

18. The computer program product of claim 15, wherein the steps further comprise:
receive an indication of disinterest for the rendered product metadata; and
rendering other product metadata as another AR overlay relative to the seller device.

19. The computer program product of claim 15, wherein the steps further comprise receiving an indication to purchase a product associated with the rendered product metadata.

20. The computer program product of claim 15, wherein sending the buyer identifier is performed in response to determining that the buyer device is proximate to the seller device.
